(19) United States
(12) Patent Application Publication
(10) Pub. No.: US 2013/0336408 A1
(43) Pub. Date: Dec. 19, 2013

(54) INFORMATION PROCESSING APPARATUS, INFORMATION PROCESSING METHOD AND NON-TRANSITORY STORAGE MEDIUM

(71) Applicant: CANON KABUSHIKI KAISHA, TOKYO (JP)

(72) Inventor: Shuichi Hosokawa, Kawasaki-shi (JP)

(21) Appl. No.: 13/905,838

(22) Filed: May 30, 2013

(30) Foreign Application Priority Data
Jun. 14, 2012 (JP) 2012-135126

(51) Int. Cl. H04N 7/26

(52) U.S. Cl. CPC H04N 19/00951
USPC 375/240.23

(57) ABSTRACT

A controller determines data length of moving image data and data length of audio data, and generates management information of a moving image file, the moving image data and the audio data being contained in the moving image file. The controller controls a decoder so that the decoder processes the audio data until a step in which the data length of the audio data can be determined and does not completely decode the audio data.

### BACKGROUND OF THE INVENTION

1. Field of the Invention

The present invention relates to an information processing apparatus, an information processing method, and a non-transitory storage medium.

2. Description of the Related Art

Conventionally, there have been various types of systems for multiplexing video coded data and audio coded data of a moving image file.

For example, MPEG-2, which is one of the multiplexing systems, uses Transport Stream (TS) and Program Stream (PS). In PS, coded data is included in a PES packet, and a packet unit of a fixed data length, called Pack, including a Pack payload constituted by a plurality of PES packets is employed. The PES packet includes in addition to a PES payload, which is coded data, a start code for enabling the head of the PES packet to be detected, and information relating to, for example, the size of the PES. Also, a Pack header in the Pack includes information for detecting a start position of the PES packet in the Pack payload, the type of included coded data, and the like. In reproduction of PS (including random access thereto), coded data to be reproduced is specified with reference to the Pack header and a PES header. That is, the Pack header and the PES header include management information necessary for reproducing the moving image file.

Accordingly, if, due to a hang-up or the like during editing of a moving image file or generation of a moving image, management information data of the Pack header and the PES header become inconsistent with coded data, the moving image file cannot be reproduced.

Japanese Patent Laid-Open No. 2009-296402 discloses a technique in which, if an inconsistency between management information data and coded data in a moving image file has been detected, the management information data is restored by searching for and analyzing a PES header and a Pack header.

Meanwhile, MP4 is one of the systems for multiplexing a moving image file.

In an MP4 format moving image file, for example, video coded data employs an H.264/MPEG-4AVC format and audio coded data employs an AAC (Advanced Audio Coding) format. The moving image file includes, in addition to Media DataBox (mdat) for storing the coded data, Movie Box (moov) for storing management information necessary for accessing each piece of coded data. Also, File Type Box (ftyp) for storing information relating to data compatibility, such as file format identification information, is included. In reproduction of the MP4 format moving image file, data compatibility is first checked with reference to the ftyp and then, on the basis of the information relating to the head of each piece of coded data obtained from the moov, the coded data in the mdat is reproduced.

In the MP4 format moving image file, different from an MPEG-2 format moving image file using a PS format, management information relating to coded data in the mdat is stored collectively in the moov. That is, in generation of the MP4 format moving image file, the moov is generated in the last process after generation of the mdat has been completed.

Therefore, if a hang-up has occurred during generation processing of the moving image file due to some kind of circumstances such as a machine trouble, there may be a case where no moov is included in the moving image file. That is, since there is no moov, the moving image file cannot be reproduced although the coded data is present.

In the MP4 format moving image file, different from a PS format moving image file, information relating to an offset value and data length of each piece of coded data is not included in the packet header. Also, since each piece of coded data is data encoded by variable-length coding, restoration or generation of the moov, which is management information of an MP4 format moving image file, is not possible by such a technology as disclosed in Japanese Patent Laid-Open No. 2009-296402.

### SUMMARY OF THE INVENTION

The present invention is made in view of such problems of the conventional technology. The present invention provides an information processing apparatus, an information processing method, and a non-transitory storage medium that restore or generate management information necessary for reproducing a moving image file that includes data encoded by variable-length coding.

According to one aspect of the present invention, there is provided an information processing apparatus comprising: an obtaining unit that obtains a moving image file, wherein the moving image file contains moving image data, which is encoded by variable-length coding, and audio data, which is encoded by variable-length coding; a decoder that decodes the moving image data and the audio data; and a controller that determines data length of the moving image data and data length of the audio data, and generates management information of the moving image file based on the data length of the moving image data and the data length of the audio data; wherein the controller controls the decoder so that the decoder does not completely decode the audio data and processes the audio data until a step in which the data length of the audio data can be determined, and determines the data length of the audio data based on a decoded result.

According to another aspect of the present invention, there is provided an information processing method comprising: obtaining a moving image file, wherein the moving image file contains moving image data, which is encoded by variable-length coding, and audio data, which is encoded by variable-length coding; determining data length of the moving image data; determining data length of the audio data by not completely decoding the audio data and processing the audio data until a step in which the data length of the audio data can be determined; and generating management information of the moving image data based on the data length of the moving image data and the data length of the audio data.

Further features of the present invention will become apparent from the following description of exemplary embodiments (with reference to the attached drawings).

### BRIEF DESCRIPTION OF THE DRAWINGS

FIG. 1 is a block diagram illustrating a functional configuration of a digital camera 100 according to an embodiment of the present invention.

FIG. 2 is a diagram illustrating processing for generating a moving image file performed by the digital camera 100 of the embodiment of the present invention.

FIG. 3 is a diagram illustrating dummy moov according to the embodiment of the present invention.

FIG. 4 is a flowchart illustrating restoration processing performed by the digital camera 100 of the embodiment of the present invention.

FIG. 5 is a flowchart illustrating analysis processing performed by the digital camera 100 of the embodiment of the present invention.

FIG. 6 is a diagram illustrating audio decoding processing and simple decoding processing according to the embodiment of the present invention.

FIGS. 7A, 7B, 7C, 7D, 7E, 7F, 7G, 7H, 7I, and 7J are diagrams each illustrating syntax of audio coded data according to the embodiment of the present invention.

FIG. 8 is a diagram illustrating an example of an operation when the analysis processing of the embodiment of the present invention is applied.

### DESCRIPTION OF THE EMBODIMENTS

Hereinafter, an exemplified embodiment of the present invention will be described in detail with reference to drawings. The embodiment below will describe an example in which the present invention is applied to a digital camera that can generate an MP4 format moving image file, as an example of an information processing apparatus and a moving image generation apparatus. However, the present invention is applicable to any apparatus that can generate management information in which at least an offset value and data length of each piece of the coded data are managed together, and add the generated management information to a moving image file that includes data encoded by variable-length coding, the management information being necessary for reproducing the moving image file.

Configuration of a Digital Camera 100

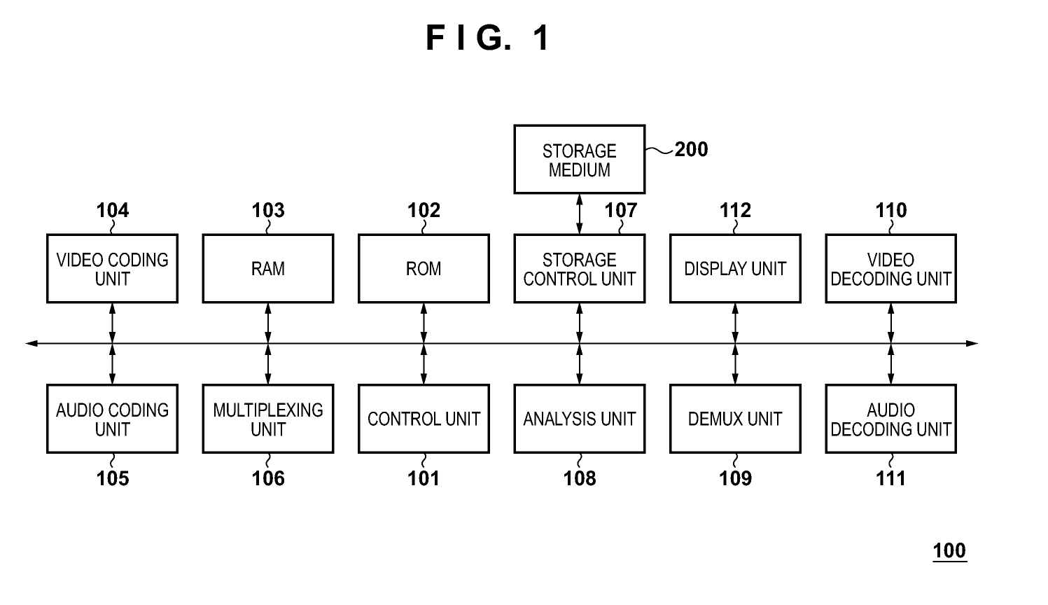

FIG. 1 is a block diagram illustrating a functional configuration of the digital camera 100 according to the embodiment of the present invention.

A control unit 101 is, for example, a CPU and controls operations of blocks included in the digital camera 100. Specifically, the control unit 101 controls the operations of the blocks by reading out a program for later-described restoration processing that is stored in a ROM 102, extracting the program on a RAM 103, and executing the program.

The ROM 102 is, for example, a rewritable nonvolatile memory and stores programs for operating the blocks included in the digital camera 100, as well as information such as parameters necessary for the operations of the blocks.

The RAM 103 is a rewritable volatile memory and serves not only as an area for extracting the programs for operating the blocks included in the digital camera 100 but also as a storage area in which intermediate data or the like output by the operations of the blocks are stored. In the present embodiment, the RAM 103 stores coded data or the like in a state prior to being stored in a later-described storage medium 200.

A video coding unit 104 subjects a video frame continuously shot by an imaging unit (not shown) to video coding processing, and generates video coded data in an H.264/MPEG-4AVC format. The video coding unit 104 outputs the generated video coded data to the RAM 103 and causes the RAM 103 to store the generated video coded data.

A frame of the video coded data includes IDR (Instantaneous Decoder Refresh) data that can be decoded only with data within one frame in a predetermined cycle, that is, that represents an intra coded picture. Generally, in a moving image file, information for specifying a position of the IDR data within the video coded data is included in the management information, thereby allowing random access to the moving image file.

An audio coding unit 105 subjects an audio signal of sounds collected by a microphone (not shown) to audio coding processing, and generates audio coded data (Raw block data) in an AAC format. The audio coding unit 105 outputs the generated audio coded data to the RAM 103 and causes the RAM 103 to store the audio coded data.

A multiplexing unit 106 multiplexes, in the RAM 103, the video coded data generated by the video coding unit 104 and the audio coded data generated by the audio coding unit 105, and generates data for an mdat in the MP4 file.

Note that although the present embodiment describes the digital camera 100 that generates an MP4 format moving image file, application of the present invention is not limited to a moving image file in this format. For example, the present invention is applicable to a multiplexing system that is similar to the MP4 format, such as a MOV format (QuickTime (Registered Trademark) Format) or a 3GPP format (Third Generation Partnership Project). That is, as described above, the present invention is applicable to any multiplexing system that includes management information, necessary for reproducing a moving image file, in which at least an offset value and data length of each piece of coded data are managed together.

A storage control unit 107 controls reading and writing of data from and to the storage medium 200 connected to the digital camera 100. The storage control unit 107 sequentially outputs, to the storage medium 200, the data that constitutes a moving image file and is stored temporarily in the RAM 103, and causes the storage medium 200 to store the data. Note that the storage medium 200 may be, for example, a memory integrated into the digital camera 100 or a storage device such as a memory card or an HDD that is detachably connected to the digital camera 100.

An analysis unit 108 analyzes a moving image file to be reproduced. Specifically, the analysis unit 108 analyzes management information of a moving image file according to the multiplexing system, and obtains information (an offset value) for specifying a position of each piece of coded data within the moving image file and information relating to data length thereof. In the present embodiment, the analysis unit 108 analyzes the mdat of the MP4 format moving image file, and thereby an offset value and data length of each piece of coded data in the mdat. Accordingly, analysis of management information by the analysis unit 108 enables the moving image file to be reproduced or random-accessed.

A demux unit 109 separates the video coded data from the audio coded data according to a file structure of the moving image file that has been analyzed by the analysis unit 108 and is to be reproduced, and transfers the respective types of coded data to a video decoding unit 110 and an audio decoding unit 111.

The video decoding unit 110 decodes the video coded data of the moving image file to be reproduced, and outputs a video signal. The output video signal is displayed on a later-described display unit 112.

The audio decoding unit 111 decodes the audio coded data of the moving image file to be reproduced, and outputs an audio signal. The output audio signal is output as audio from a speaker (not shown) in synchronization with display of the video signal on the display unit 112.

The display unit 112 is a display device such as a LCD device included in the digital camera 100. The display unit 112 displays on its display section a video frame of a moving image file that has been output by the video decoding unit 110 and is to be reproduced, a live view frame image output by an imaging unit (not shown), and the like.

Note that although the present embodiment is described in which processing is implemented in each block included as hardware in the digital camera 100, implementation of the present invention is not limited to this and processing in each block may be implemented by a program that executes the same processing as that in each block. Alternatively, each block in FIG. 1 may be configured by stand-alone hardware or part or all of functionalities of a plurality of blocks may be configured by one or more piece of hardware. Alternatively, part or all of functionalities of each block in FIG. 1 may be executed by a program that is read out from the ROM 102 and extracted on the RAM 103, by the control unit 101.

Generation of a Moving Image File

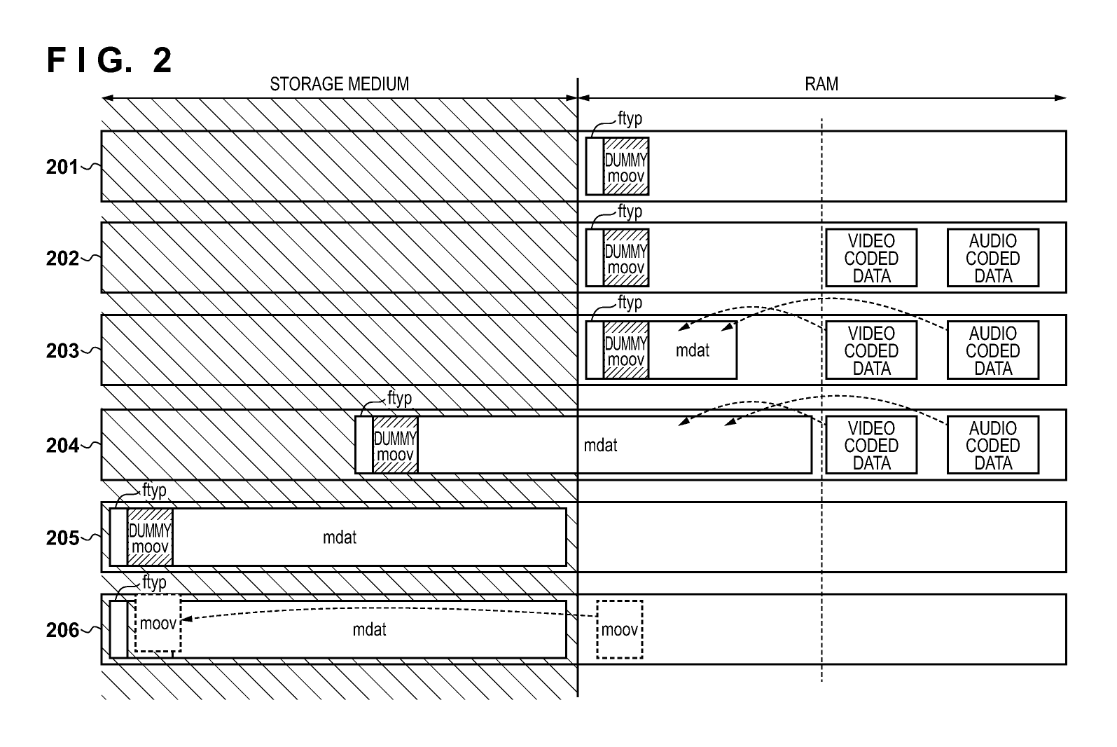

The following will briefly describe generation of an MP4 format moving image file in the digital camera 100 of the present embodiment, with reference to FIG. 2. FIG. 2 illustrates a flow of data to be temporarily stored in the RAM 103 and a moving image file to be stored in the storage medium 200, at the time of shooting a moving image.

First, upon detecting that shooting of a moving image has been instructed by an operation input unit (not shown), the control unit 101 generates an ftyp that includes information indicating that a moving image file to be generated is in an MP4 format, and causes the RAM 103 to store the ftyp. Also, the control unit 101 generates a dummy moov, which is temporarily given to the moving image file to be generated, and connects the dummy moov to the ftyp of the RAM 103 as shown in a status 201 so as to cause the RAM 103 to store the dummy moov. Note that this dummy moov is not management information for making a moving image file to be generated reproducible but is given so that it is not determined to be a legitimate moov at the time of reproduction when no legitimate moov has been generated. Note that the dummy moov includes information necessary for generating the legitimate moov, as will be described later.

### Dummy Moov

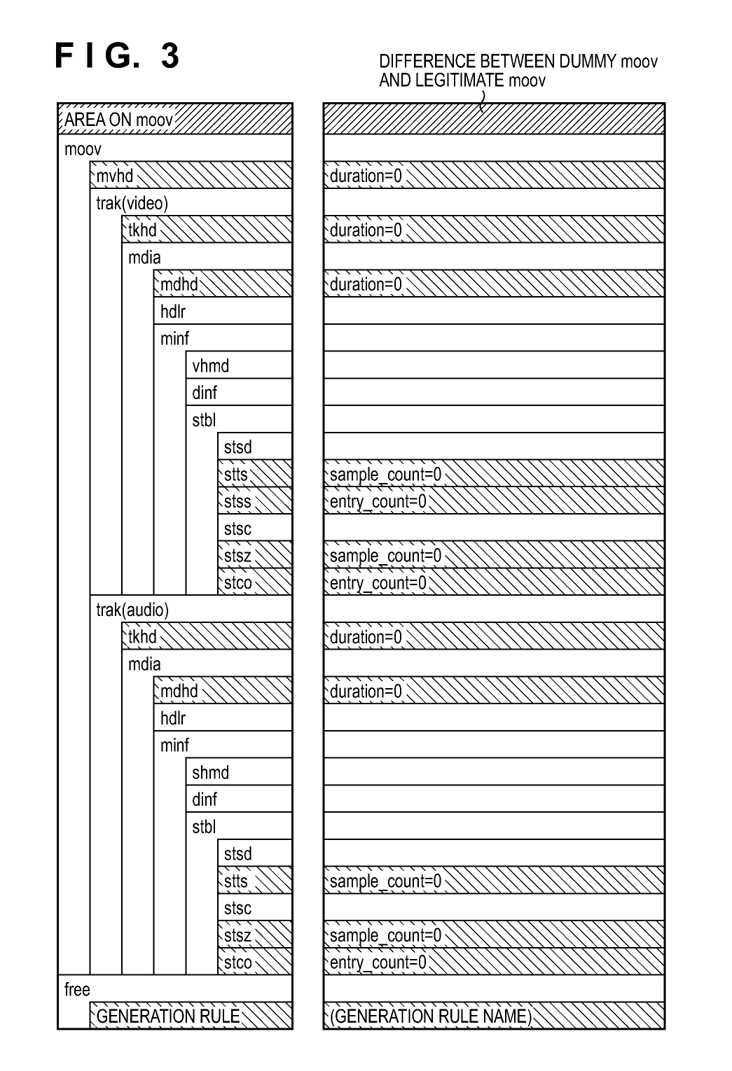

The following will describe a difference between a dummy moov, which is temporarily given at the time of generating a moving image file by the digital camera 100 of the present embodiment, and a legitimate moov with reference to FIG. 3.

The moov contains, in addition to information that can be generated only after generation of the mdat to be included in the moving image file has been completed, information that can be obtained before the generation of the mdat. Examples of the information that can be obtained before the generation of the mdat include information predetermined for generation of coded data, such as the display resolution or the frame rate at the time of reproducing video data of the moving image file, and the sampling frequency of audio data of the moving image file.

The dummy moov of the present embodiment differs from the legitimate moov only in information shown by hatching in FIG. 3. Among the information shown by hatching, information included in a moov layer of the dummy moov is information that can be generated only after generation of an mdat included in the moving image file has been completed. Also, among the information included in the moov layer, information that is not shown by hatching is information that can be obtained before the generation of the mdat. Specifically, the moov layer of the dummy moov indicates that the number of pieces of coded data stored in the moving image file is 0, and duration of each sub layer is set to 0.

Also, in FIG. 3, the dummy moov includes, in addition to the moov layer, a free layer that includes generation rule information (generation information) relating to a generation rule used for generation of an mdat. The mdat has a repeated structure in which a video chunk configured by video coded data and an audio chunk configured by audio coded data are alternately arranged. Therefore, the generation rule information includes:

1) Information relating to the numbers of pieces of coded data included in each unit chunk (with respect to each of the video chunk and the audio chunk); and

2) Information relating to arrangement order of the video chunk and the audio chunk (as to which of the video chunk and the audio chunk is arranged at the head).

Also, with respect to generation of the video coded data, the generation rule information further includes:

3) Information relating to the number of NAL units (that are assigned to the head of an access unit and store information relating to the data length of the access unit) that are included in one piece of video coded data; and

4) Information relating to appearance cycle of IDR data in the video coded data.

As described, the generation rule information is information for defining configuration of an mdat of a moving image file and a method for generating of the mdat, that is, information defined in advance, for example, for the digital camera 100. The video coding unit 104, the audio coding unit 105, and the multiplexing unit 106 sequentially connect the pieces of coded data that have sequentially been generated in accordance with the generation rule information, and generate in the RAM 103 the mdat in which the video coded data and the audio coded data are multiplexed.

As will be described later, the generation rule information is referenced also for generation of the legitimate moov when the generation of the mdat of a moving image file has been completed. That is, in the digital camera 100 of the present embodiment, at the time of generation of a moving image file, the moving image file contains in advance the dummy moov including the generation rule information prior to completion of the mdat. With this, even if generation of the moving image file has hung up before generation of the legitimate moov, the digital camera 100 can restore the legitimate moov by analyzing the remaining mdat.

In this manner, after having generated the dummy moov including the generation rule information for use for generation of the moving image file, the control unit 101 starts moving image shooting processing and causes the video coding unit 104 and the audio coding unit 105 to generate sequentially video coded data and audio coded data.

When the coded data have been generated by the video coding unit 104 and the audio coding unit 105, and have been stored in the RAM 103 (status 202), the control unit 101 causes the multiplexing unit 106 to execute multiplexing processing in accordance with the generation rule information. When moving image data (part of the mdat) constituted by the video chunk and the audio chunk has been generated by the multiplexing unit 106, the control unit 101 sequentially connects the moving image data to data in which the ftyp and the moov are connected, and generates a moving image file (status 203). Also, when the moving image file having a predetermined file size has been generated, the control unit 101 transfers this data to the storage control unit 107, and causes the storage medium 200 to store the data (status 204).

Upon detecting that stop of the shooting of the moving image has been instructed, the control unit 101 stops the moving image shooting processing so as to stop coding processes of the video coding unit 104 and the audio coding unit 105. Also, the control unit 101 generates all the mdat, transfers them to the storage control unit 107, and causes the storage medium 200 to store them in the mdat of the moving image file (status 205).

Thereafter, with reference to the information relating to the data length of the pieces of coded data, the chunks, and the like that have been obtained at the time of the coding processing, the control unit 101 generates the legitimate moov in accordance with the generation rule information. Also, the control unit 101 transfers the legitimate moov to the storage control unit 107, updates the dummy moov of the moving image file stored in the storage medium 200 to the legitimate moov, and completes the moving image file (status 206: completing processing).

Note that the generation of the legitimate moov is executed by adding information to the same data as in the dummy moov in a following manner:

A) Input a duration for one piece of coded data to stts;

B) Input to a duration of tkhd/mdhd a value obtained by multiplying the number of pieces of coded data registered in the mdat by duration for one piece of coded data;

C) Input to stss a value obtained from a generation rule 4 and the number of pieces of the video coded data registered in the mdat (for example, when IDR data appears at intervals of 15 pieces of video coded data and the number of the registered pieces of video coded data is 100, a value that meets 1+15×n≦100 (n=0, 1, 2 . . . ), that is, 1, 16, 31, 46, 61, 76, and 91 are sequentially registered in stss);

D) Input to stsz the data lengths of the pieces of coded data output from the video coding unit 104 and the audio coding unit 105;

E) Input to stco a value that is obtained by adding the data lengths of the pieces of coded data in accordance with generation rules 1 and 2, and specifies positions of the respective pieces of coded data in the moving image file (offset values)

F) Discard the generation rule area of the free layer (padding by 0x00).

Reproduction processing (in the case where a legitimate moov is present)

When reproducing the moving image file that has been generated in such a manner, the control unit 101 performs procedures in the reproduction processing as follows.

The control unit 101 causes the storage control unit 107 to read out from the storage medium 200 an ftyp of the moving image file whose reproduction has been instructed and, if the control unit 101 recognized with reference to this information that the moving image file is in an MP4 format, the control unit 101 then causes the storage control unit 107 to read out a moov and to store the moove in the RAM 103.

The control unit 101 analyzes (parses) the structure of the moov stored in the RAM 103, and obtains information relating to the resolution and the frame rate of the video data, and the sampling frequency and the like of the audio data with reference to stsd within the moov. Then, the control unit 101 sets the obtained information in the video decoding unit 110 and the audio decoding unit 111.

Next, the control unit 101 obtains, with reference to stco and stsz within the moov, information relating to an offset value and data length of each piece of coded data. Based on the information, the control unit 101 causes the storage control unit 107 to read out data of the mdat from the storage medium 200 to the RAM 103 and causes the demux unit 109 to separate the data of the mdat into video coded data and audio coded data. Also, the control unit 101 transfers the respective types of coded data to the video decoding unit 110 and the audio decoding unit 111 so as to cause them to decode the respective types of coded data. The control unit 101 outputs a video signal obtained by the decoding processing of the video decoding unit 110 to the display unit 112, and causes the display unit 112 to display the video signal. Also, the control unit 101 outputs an audio signal obtained by the decoding processing of the audio decoding unit 111 to a speaker (not shown), and causes the speaker to reproduce the audio signal.

The control unit 101 repeatedly executes such procedures until all pieces of coded data included in the mdat of the moving image file whose reproduction has been instructed are decoded and reproduced or until it is detected that stop of the reproduction is instructed, thereby reproducing the moving image file.

Reproduction Processing (in the Case where No Legitimate Moov is Present)

On the other hand, a case will be considered in which a hang-up has occurred due to a factor such as a power-off operation of the digital camera 100 during processing for generating a moving image file, i.e., from starting to store the mdat in the storage medium 200 to updating to the legitimate moov after completion of generation of the mdat.

At that time, in the storage medium 200, there is a moving image file that includes a dummy moov, and an mdat that contains at least one chunk of pieces of coded data (a video chunk and an audio chunk). As described above, when reproduction of such a moving image file is instructed, the control unit 101 cannot obtain information relating to an offset value and data length of each piece of coded data of the moving image file even if the control unit 101 has parsed the dummy moov. That is, since the control unit 101 cannot obtain the information relating to the pieces of coded data included in the mdat of the moving image file, the control unit 101 cannot reproduce the moving image file.

In the present embodiment, from such a moving image file in which no legitimate moov is present, a moving image file including a legitimate moov is generated by analyzing the dummy moov and the mdat.

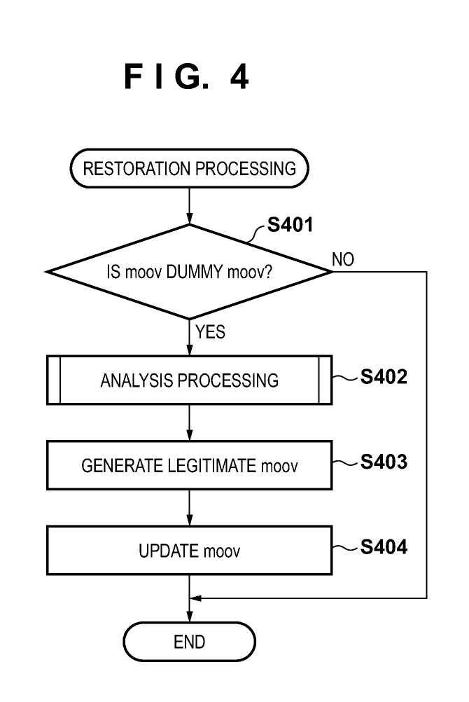

Restoration Processing The following will describe specific restoration processing performed by the digital camera 100 of the present embodiment in which a moving image file of the digital camera 100 including no legitimate moov is restored and a moving image file including a legitimate moov is generated, with reference to a flowchart in FIG. 4. The procedures that correspond to the flowchart can be realized by the control unit 101 reading out a corresponding processing program stored in, for example, the ROM 102, and extracting the processing program on the RAM 103 so as to execute the processing program. Note that the description is made in which the present restoration processing starts at the time when reproduction of a moving image file stored in, for example, the storage medium 200 is instructed.

In step S401, the control unit 101 determines whether or not a moov of a moving image file (target moving image file) whose reproduction has been instructed is a dummy moov. Specifically, the control unit 101 causes the storage control unit 107 to read out the moov of the target moving image file stored in the storage medium 200 and to store the read moov in the RAM 103. The control unit 101 determines whether or not the moov is a dummy moov by determining whether or not the moov has, for example, mvhd whose duration is 0. If the control unit 101 determines that the moov of the target moving image file is a dummy moov, it then shifts the processing to step S402, and if the control unit 101 determines that the moov of the target moving image file is not a dummy moov, it terminates the restoration processing.

In step S402, the control unit 101 executes analysis processing for analyzing an mdat of the target moving image file.

Analysis Processing

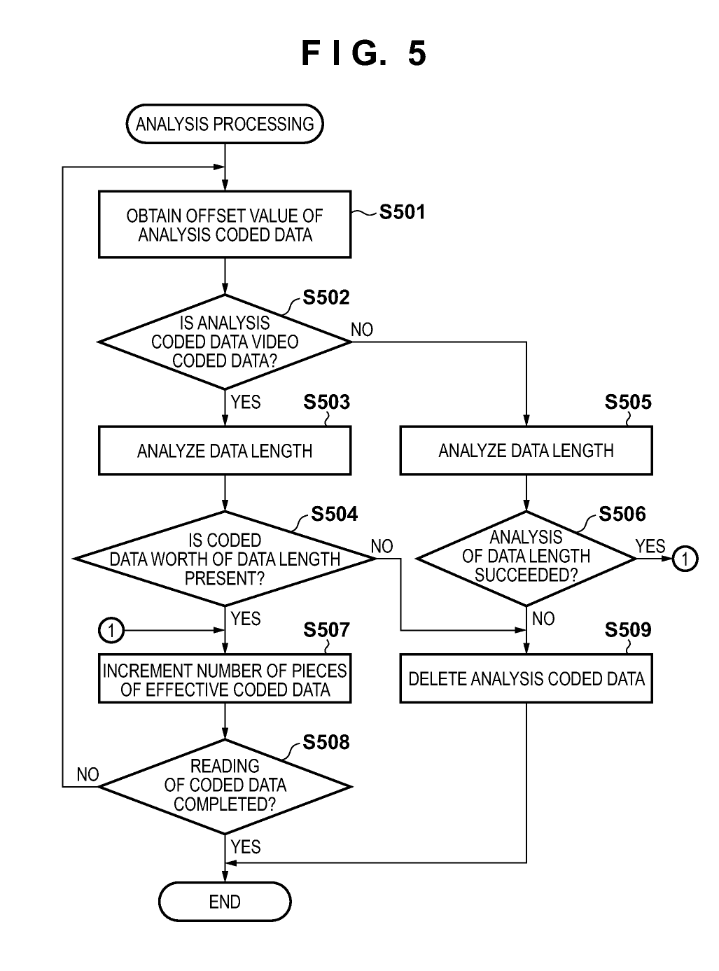

Hereinafter, analysis processing performed by the digital camera 100 of the present embodiment will be described in detail with reference to FIG. 5.

In step S501, the control unit 101 obtains an offset value of a head position of the coded data (analysis coded data) to be analyzed in the target moving image file. Specifically, the control unit 101 first adds the data length of the dummy moov read on the RAM 103 to a predetermined data length of an ftyp, and calculates an offset value of the head position of the mdat. Further, the control unit 101 adds thereto information relating to the sum of the data lengths of the pieces of coded data that have already been analyzed, and thereby obtains an offset value of the head position of the analysis coded data.

In step S502, the control unit 101 determines whether or not the analysis coded data is video coded data with reference to the generation rules 1 and 2 included in the dummy moov. The control unit 101 sequentially determines which type of coded data the analysis coded data selected in process of the present analysis processing is, with reference to information relating to the arrangement order of the video chunk and the audio chunk starting from the head of the mdat and information relating to the numbers of the corresponding types of coded data included in the respective chunks. If the control unit 101 determines that the analysis coded data is video coded data, it then shifts the processing to step S503, and if the control unit 101 determines that the analysis coded data is not video coded data, i.e., audio coded data, it then shifts the processing to step S505.

In step S503, the control unit 101 causes the analysis unit 108 to analyze data length of the video coded data that is the analysis coded data. Specifically, the analysis unit 108 reads out an NAL unit from the head of the analysis coded data (data obtainment) and obtains data length of an access unit that corresponds to the NAL unit. Further, the analysis unit 108 reads out a next NAL unit that is located at a position shifted by the data length of the obtained access unit, and obtains data length of an access unit that corresponds to the next NAL unit. By obtaining data lengths of access units corresponding to all NAL units included in the analysis coded data in accordance with a generation rule 3 included in the dummy moov, and adding up the obtained data lengths, the analysis unit 108 analyzes the data length of the video coded data that is the analysis coded data.

In step S504, the control unit 101 determines whether or not coded data worth of the obtained data length of the analysis coded data is present in the mdat. If the target moving image file is a file in which a hang-up of the moving image generation processing has occurred during writing of the coded data included in the mdat into the storage medium 200, the coded data that was being written at the time of the hang-up includes EOF at the back-end of data that has been written before the hang-up. That is, the control unit 101 determines whether or not EOF, which indicates the back-end of the target moving image file, appears before coded data worth of the data length of the analysis coded data analyzed by the analysis unit 108 has been read out from the mdat of the storage medium 200. If the control unit 101 determines that the coded data worth of the data length of the analysis coded data is present in the mdat, the control unit 101 shifts the processing to step S507, and if the control unit 101 determines that it is not present in the mdat, the control unit 101 shifts the processing to step S509.

On the other hand, in step S502, if it has been determined that the analysis coded data is audio coded data, the control unit 101 causes, in step S505, the analysis unit 108 to analyze data length of the audio coded data that is the analysis coded data. Different from the video coded data, the audio coded data does not include an NAL unit having data length information. Therefore, in the present embodiment, the analysis unit 108 subjects the audio coded data to simple decoding processing (in which data is not completely decoded) that is part of audio decoding processing executed in the audio decoding unit 111, thereby detecting information relating to the end of the audio coded data. Then, the analysis unit 108 obtains the data length of the audio coded data based on the information relating to the end.

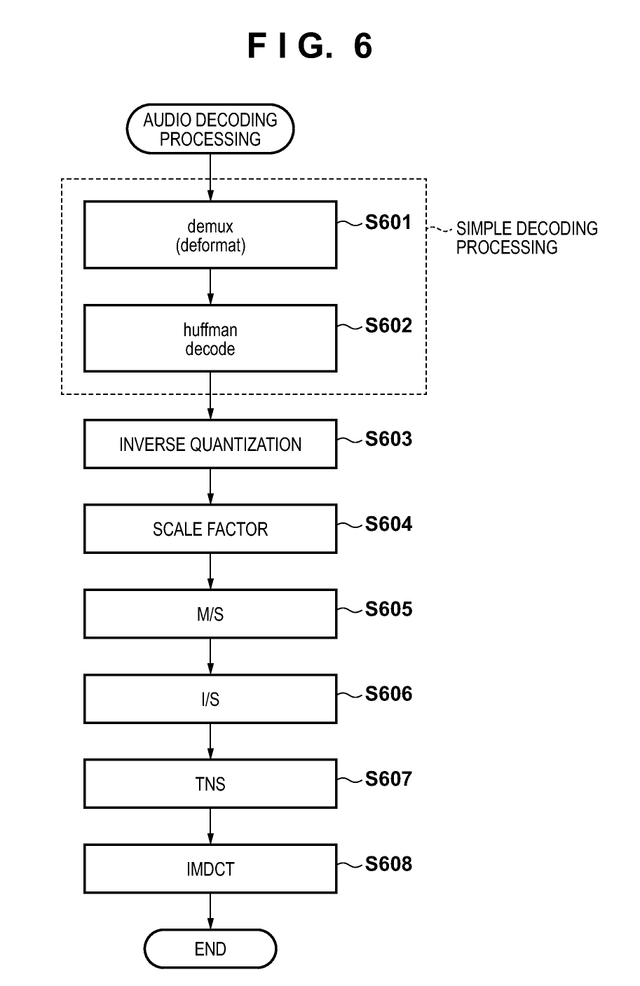

The audio decoding processing performed by the audio decoding unit 111 is executed by steps shown, for example, in FIG. 6. The audio decoding unit 111 subjects the input audio coded data in an AAC format to data syntax analysis in the procedures in steps S601 and S602, and reads out constituent elements. The audio decoding unit 111 subjects the read constituent elements to inverse quantization (S603), scale factor processing (S604), M/S processing (S605), I/S processing (S606), TNS processing (S607), and inverse modified discrete cosine transform (IMDCT) processing (S608), so as to generate an audio signal. Note that the processing in step S608 may be inverse discrete cosine transform (IDCT) processing.

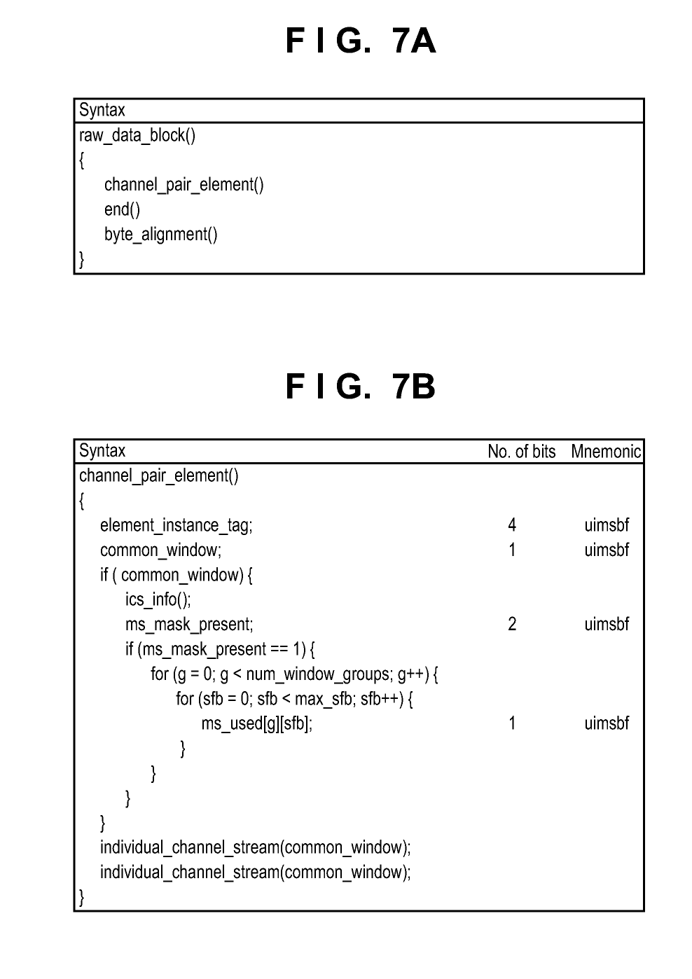

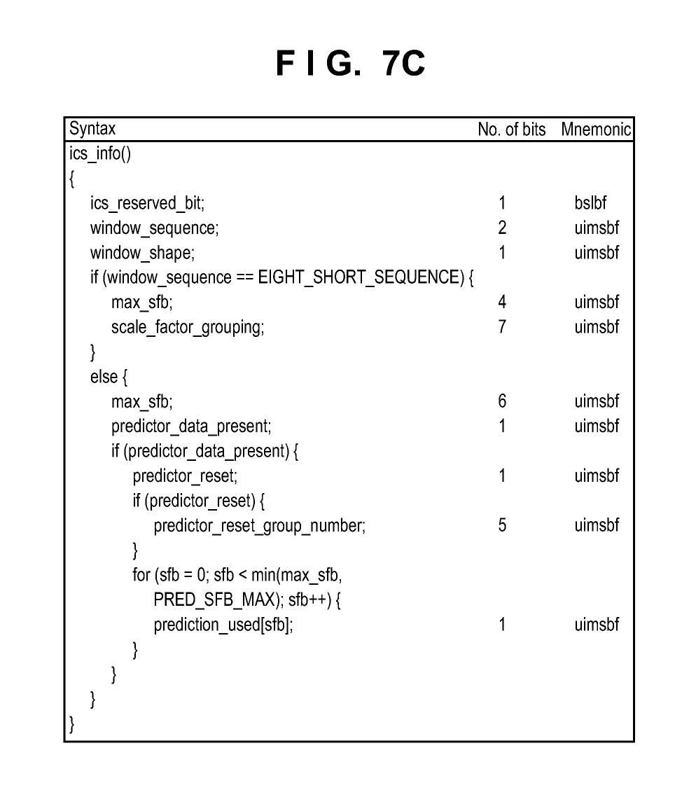

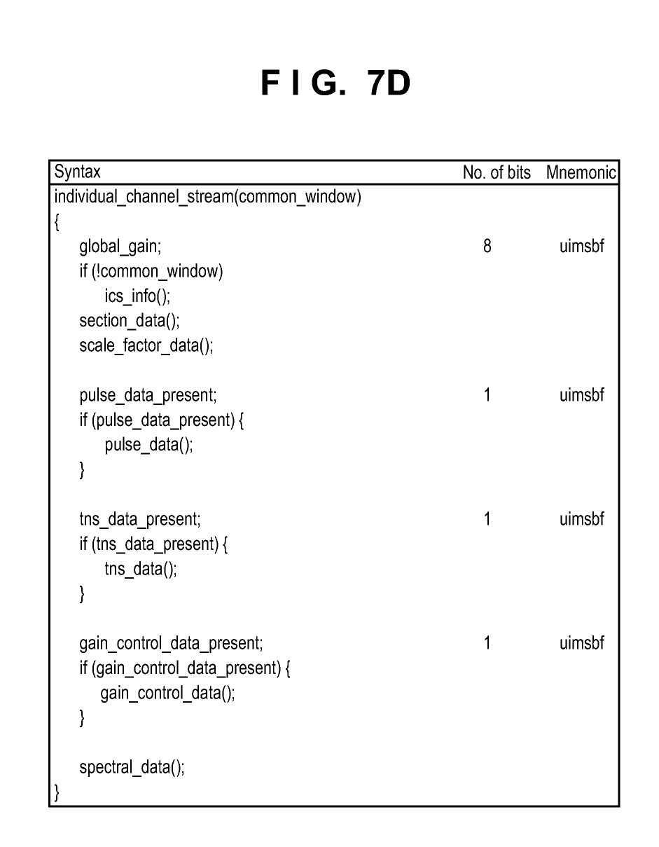

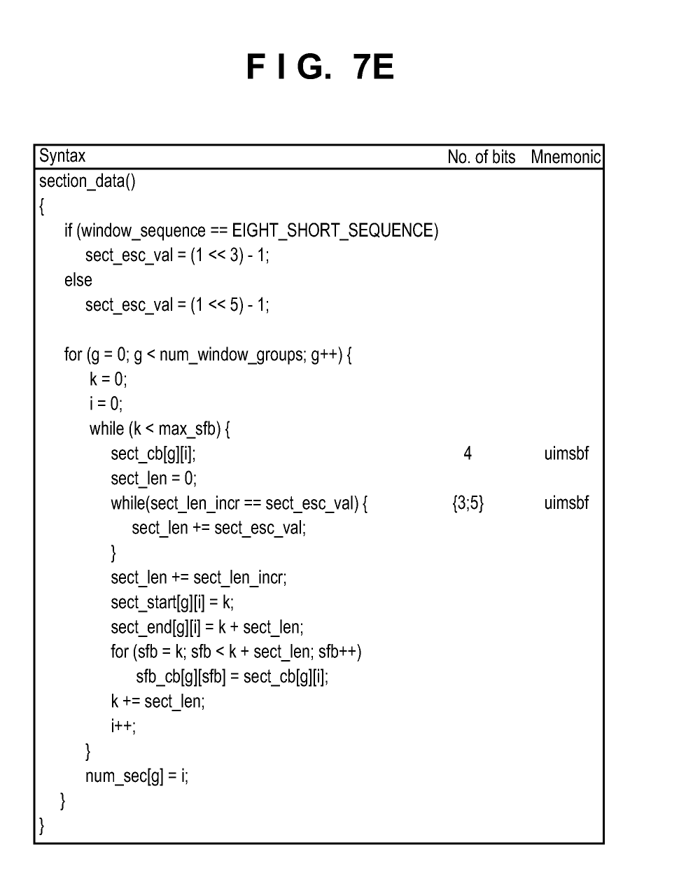

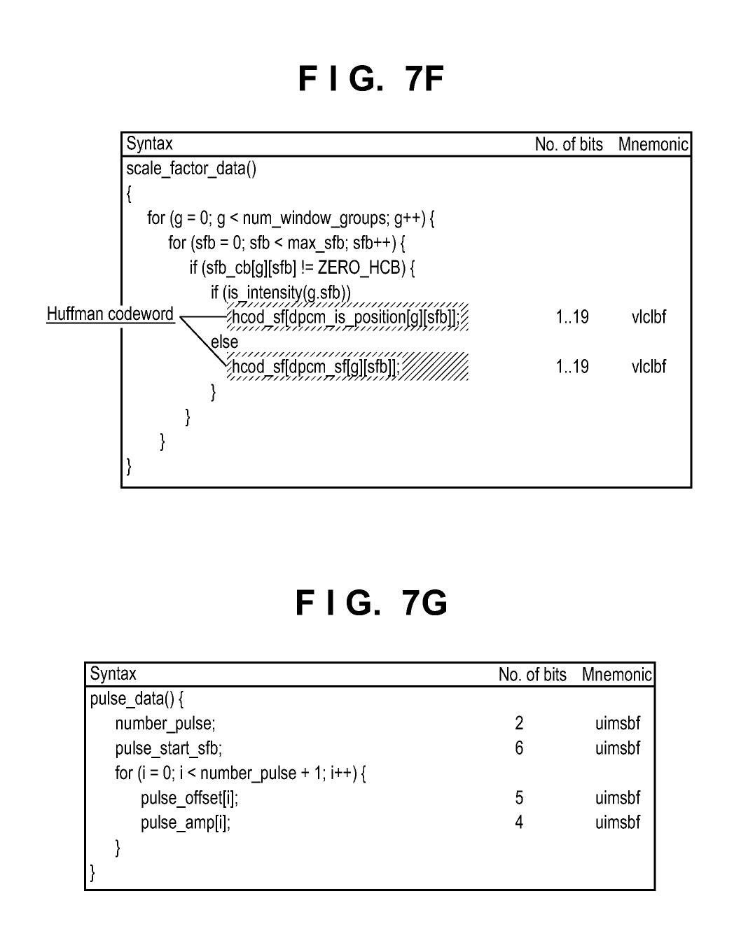

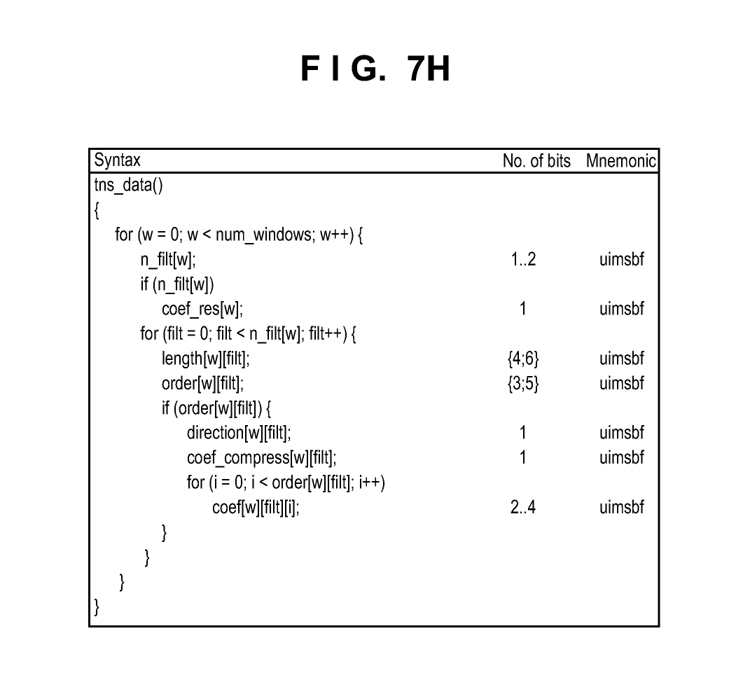

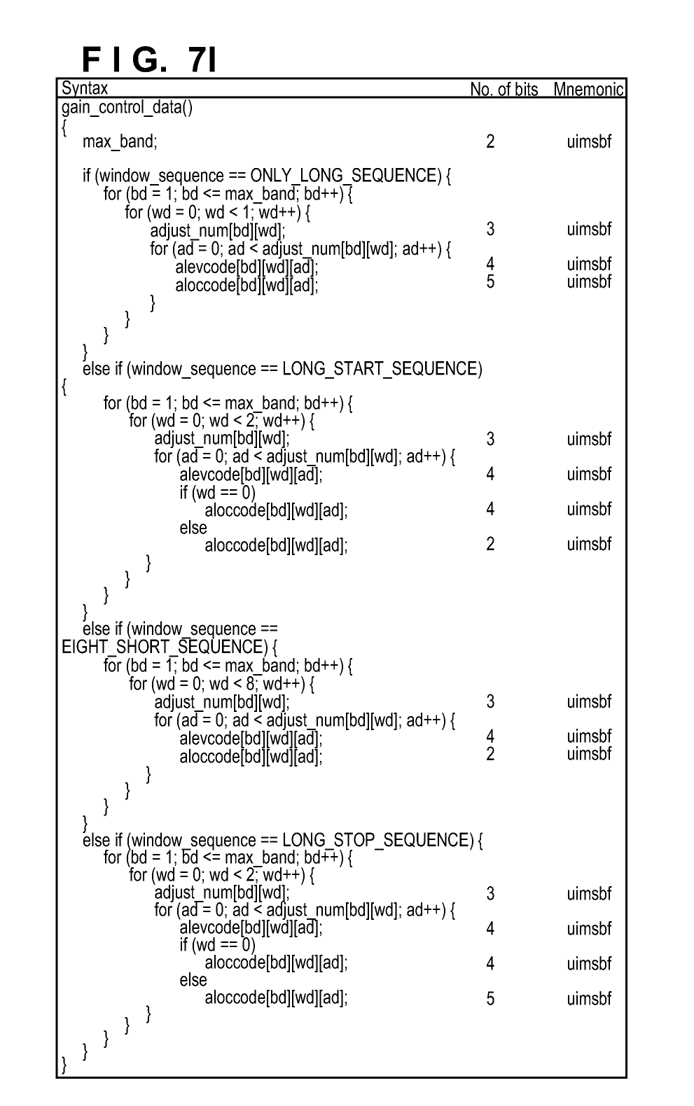

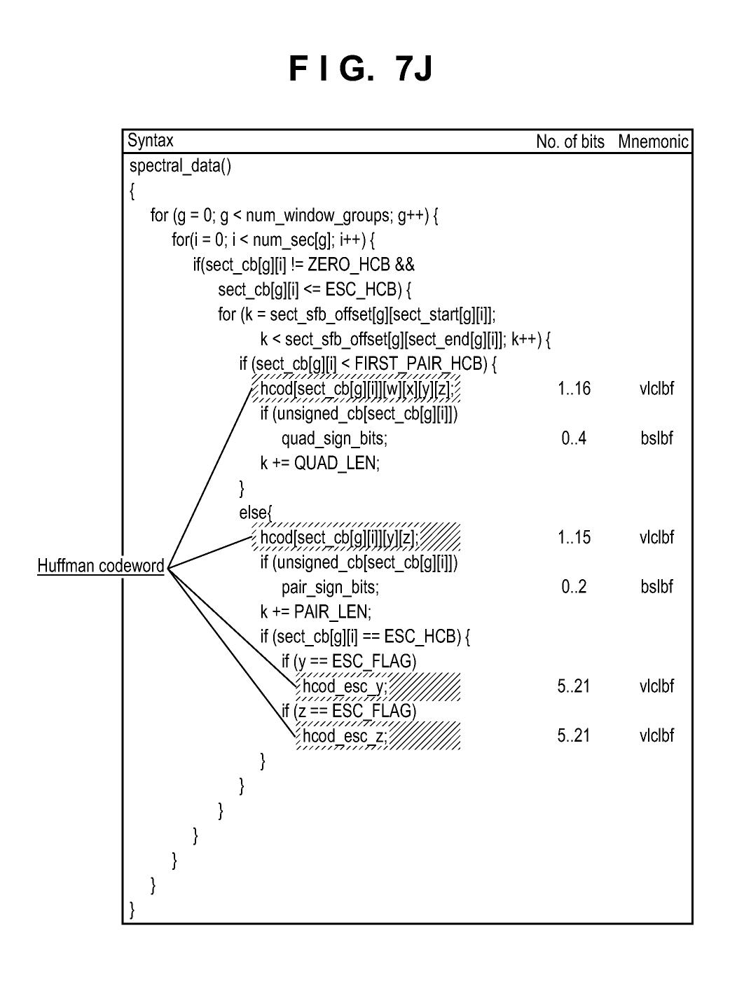

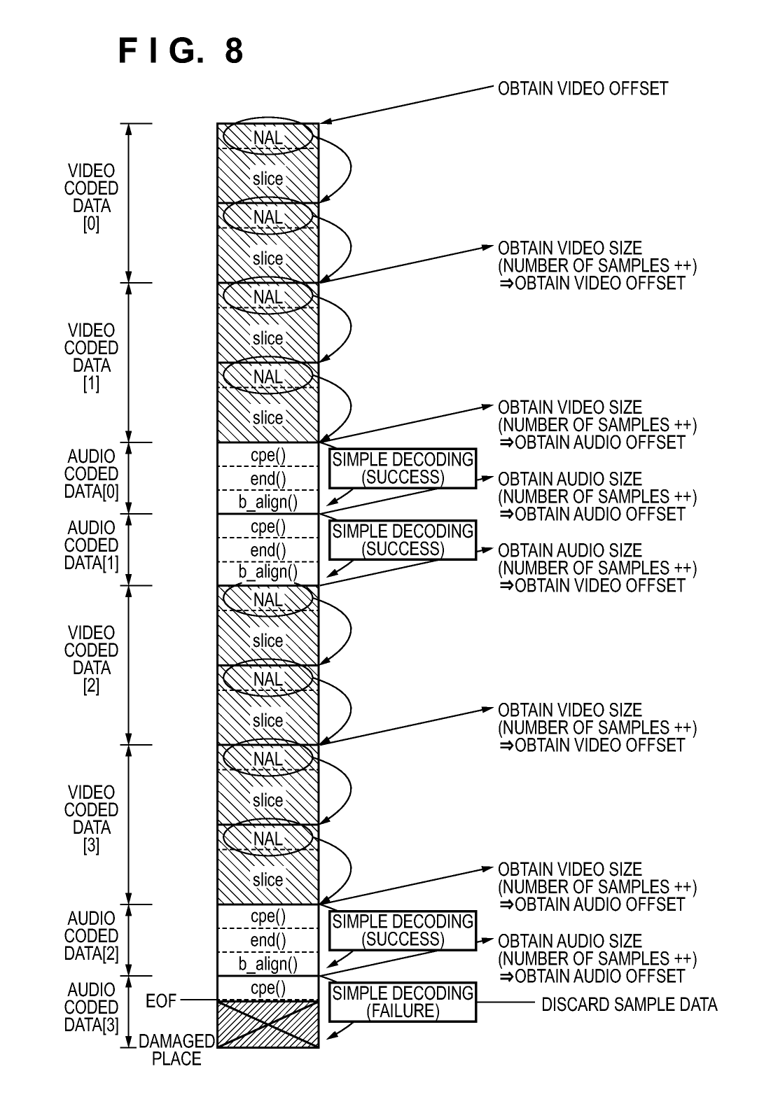

As shown in the syntax in FIG. 7A, Raw block data (raw_block_data( )) that is audio coded data is constituted by:

channel_pair_elements( ) including data encoded by variable-length coding in L/R channels;

end( ) indicating information relating to the end of raw_block_data( ) and

byte_alignment( ) for adjusting raw_block_data( ) to byte alignment.

As shown in FIG. 7B, syntax of channel_pair_element( ) is divided into individual_channel_stream(common_window) that indicates pieces of coded data of the audio signal in the L and R channels, and other pieces of information. With respect to other pieces of information of channel_pair_element( ) the numbers of bits are known, as shown in FIGS. 7B and 7C.

Also, individual_channel_stream(common windo_) has syntax as shown in FIG. 7D. Constituent elements of the individual piece of the audio coded data as shown in FIG. 7D are described with syntax as shown in FIGS. 7E to 7J. As shown, scale_factor_data( ) and spectral_data( ) of the elements constituting the audio coded data include constituent elements compressed by Huffman coding. Therefore, in order to calculate the numbers of bits of each constituent element, Huffman decoding processing is needed.

Accordingly, the analysis unit 108 causes, in step S505, the audio decoding unit 111 to perform the data syntax analysis of the audio decoding processing. Also, while causing the audio decoding unit 111 to read out the constituent elements of the audio coded data to be analyzed, the analysis unit 108 counts the numbers of bits of the read data, thereby obtaining the data length of the audio coded data to be analyzed. Specifically, the analysis unit 108 causes the audio decoding unit 111 to execute the simple decoding processing, in which only the procedures in steps S601 and S602 of the audio decoding processing are executed, until byte_alignment( ) is detected by the syntax analysis. Also, the analysis unit 108 obtains the total number of bits of the data that have been read out up to the constituent element as the data length of the analysis coded data. Note that in the present step, data in the mdat to be read out from the storage medium 200 for the simple decoding processing may be data worth of a predetermined data length that is larger than that of one piece of audio coded data from the head position of the analysis coded data.

In step S506, the control unit 101 determines whether or not the analysis of data length of the analysis coded data in step S505 has succeeded. As described above, if the target moving image file is a file in which a hang-up of the moving image generation processing has occurred during writing of the coded data included in the mdat in the storage medium 200, not all pieces of the coded data that was being written at the time of the hang-up may have been written. That is, if the target moving image file is such a file, the audio decoding unit 111 cannot detect byte_alignment( ) in the analysis of data length of the analysis coded data using the simple decoding processing in step S505. Therefore, the analysis unit 108 fails to analyze the data length of the analysis coded data. If the control unit 101 determines that the analysis of data length of the analysis coded data has succeeded, it shifts the processing to step S507, and if the control unit 101 determines that the analysis of data length of the analysis coded data has failed, it shifts the processing to step S509.

In step S507, the control unit 101 increments by one the number of pieces of effective coded data of the corresponding coded data included in the mdat of the moving image file stored in the RAM 103. Also, the control unit 101 stores information relating to the data length of the analysis coded data in the RAM 103 in association with the effective coded data number (information indicating what number from the head the coded data is).

In step S508, the control unit 101 determines whether or not reading of all the coded data included in the mdat of the target moving image file has been completed. Specifically, the control unit 101 determines whether or not EOF is present at a position shifted from the head position of the analysis coded data by the data length of the data that has been analyzed. If the control unit 101 determines that the reading of all the coded data included in the mdat has been completed, it terminates the present analysis processing, and if the control unit 101 determines that the reading of all the coded data included in the mdat has not been completed, it returns the processing to step S501.

Also, if the analysis coded data is damaged, the control unit 101 deletes, in step S509, the analysis coded data from the mdat of the target moving image file stored in the storage medium 200, and terminates the present analysis processing. In other words, the control unit 101 deletes the data that is present at and after the head position of the analysis coded data, among the data in the mdat of the target moving image file stored in the storage medium 200.

By executing analysis processing in this manner, the control unit 101 can output the following pieces of information with respect to the target moving image file to the RAM 103:

Information relating to the number of pieces of the coded data included in the mdat (the number of chunks);

Information for specifying the position of each piece of the coded data included in the mdat; and

Information relating to the data length of each piece of the coded data included in the mdat.

Also, in step S403, on the basis of the information obtained by the analysis processing, the control unit 101 inputs necessary information to the dummy moov that has been read out on the RAM 103, and generates a legitimate moov. Note that at that time, the control unit 101 deletes the generation rule information included in the dummy moov.

In step S404, the control unit 101 transmits the generated legitimate moov to the storage control unit 107, and updates the dummy moov of the target moving image file stored in the storage medium 200 to this data, and then terminates the present restoration processing.

With these measures, even if a moving image file includes no legitimate moov, it is possible to generate a moving image file including a legitimate moov by analyzing an mdat included in the moving image file. Also, the generation of the legitimate moov allows the moving image file to be reproducible.

### Application Examples

The following will describe an example in which the above-described analysis processing is applied, with reference to the drawings.

A case will be considered in which an mdat has a configuration as shown in FIG. 8 and a generation rule is as follows.

1) The number of pieces of video coded data in each video chunk is 2, and the number of pieces of audio coded data in each audio chunk is 2;

2) The mdat is constituted by the video chunk and the audio chunk in this order; and

3) The number of NAL units in each piece of video coded data is 2.

First, since it is determined from the generation rule 2 that the coded data that is present at the head of the mdat is video coded data, the control unit 101 sets the head position of a payload unit of the mdat to an offset value of the video coded data [0].

Next, the analysis unit 108 reads out data length information of an NAL unit located at the head of the video coded data [0], and reads out next data length information located at a position shifted by the data length indicated by the information of the NAL unit at the head. Since it is determined from the generation rule 3 that two NAL units are included in each piece of video coded data, the analysis unit 108 adds up the data lengths indicated by the two pieces of data length information, and obtains data length of the video coded data [0].

The value obtained by adding the data length of the video coded data [0] to the offset value thereof is an offset value of next coded data. Since it is determined from the generation rule 1 that the next coded data is video coded data, the offset value will be an offset value of video coded data [1].

The analysis unit 108 similarly analyzes the video coded data [1] and obtains data length thereof. At that time, the control unit 101 increments by one the number of pieces of effective video coded data of the video coded data.

Since it is determined from the generation rule 1 that next coded data is audio coded data, the control unit 101 sets the value obtained by adding the data length of the video coded data [1] to the offset value thereof, to the offset value of the next audio coded data [0].

The analysis unit 108 reads out data of predetermined 2048 bytes (LPCM-Streo 16 bits/1024 samples) from the start position of the audio coded data [0], and causes the audio decoding unit 111 to execute the simple decoding processing. Since by the simple decoding processing, byte_alignment( ) of the audio coded data [0] is detected and the data length is obtained, the analysis unit 108 sets the data length to the data length of the audio coded data [0].

By sequentially executing the procedures in this manner, it is possible to analyze information of each piece of the coded data included in the mdat. Note that, by the simple decoding processing, the analysis unit 108 cannot obtain the data length of audio coded data [3] that is located at the tail end of the mdat and damaged. Therefore, the control unit 101 deletes data that is located at and after the start position of the audio coded data [3] from the mdat stored in the storage medium 200. Then, the control unit 101 regards data up to the tail end of the audio coded data [2] as effective coded data of the mdat, and ends the analysis processing.

As has been described above, the information processing apparatus of the present embodiment can restore or generate management information necessary for reproducing a moving image file that includes data encoded by variable-length coding. Specifically, the information processing apparatus obtains a moving image file in which a first chunk constituted by a first type of pieces of data encoded by variable-length coding and a second chunk constituted by a second type of pieces of data encoded by variable-length coding are alternately arranged. Also, generation information is also obtained that includes at least information relating to the arrangement order of the first chunk and the second chunk, and information relating to the number of pieces of data encoded by variable-length coding that are included in each unit chunk. Then, the information processing apparatus analyzes the data length of the first type of pieces of data encoded by variable-length coding by analyzing the data length information included in the data encoded by variable-length coding. Then, the information processing apparatus analyzes the data length of the second type of pieces of data encoded by variable-length coding, by applying simple decoding processing for detecting at least the information indicating the end of the data encoded by variable-length coding. Then, using the analyzed data lengths of the pieces of data encoded by variable-length coding, management information necessary for reproducing the moving image file is generated, and is output such that the management information is included in the moving image file.

Note that the present embodiment has described in which, when a moving image file is generated, a dummy moov including generation rule information for generation of an mdat is generated, and then pieces of data in the mdat are sequentially connected to one another. However, the present invention is also applicable to other cases than a case using the moving image file in which generation rule information is included as a dummy moov. The generation rule information for generation of the mdat is information that is predetermined for the moving image generation apparatus, so that if the above-described restoration processing is executed within an apparatus that has generated the moving image file, the generation rule information is not necessarily included in the moving image file. Also, for example, a moving image browsing application for executing restoration processing may be configured to specify, on the basis of information on an apparatus that has generated a moving image file, a generation rule applied from prepared patterns of generation rules and to use the specified generation rule. Although in the present embodiment, the generation rule information is stored in the dummy moov, it is not necessary to configure like this. That is, restoration of a moving image file is possible without storing this information in the dummy moov as long as the moving image file is generated such that, for example, an offset position (the head position of the mdat) at the head of the data encoded by variable-length coding is located at a position shifted by the predetermined number of bytes from the head of the file.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-135126, filed Jun. 14, 2012, which is hereby incorporated by reference herein in its entirety.

What is claimed is:

1. An information processing apparatus comprising:
an obtaining unit that obtains a moving image file, wherein the moving image file contains moving image data, which is encoded by variable-length coding, and audio data, which is encoded by variable-length coding;
a decoder that decodes the moving image data and the audio data; and
a controller that determines data length of the moving image data and data length of the audio data, and generates management information of the moving image file based on the data length of the moving image data and the data length of the audio data;
wherein the controller controls the decoder so that the decoder does not completely decode the audio data and processes the audio data until a step in which the data length of the audio data can be determined, and determines the data length of the audio data based on a decoded result.

2. The information processing apparatus according to claim 1, wherein the controller stores the generated management information and the moving image file in a storage medium in association with each other.

3. The information processing apparatus according to claim 1, wherein the controller controls the decoder so that the decoder does not execute inverse quantization of the audio data when processing the audio data until the step in which the data length of the audio data can be determined.

4. The information processing apparatus according to claim 1, wherein the controller controls the decoder so that the decoder does not execute inverse discrete cosine transform of the audio data when processing the audio data until the step in which the data length of the audio data can be determined.

5. The information processing apparatus according to claim 1, wherein the controller generates the management information if the moving image file obtained by the obtaining unit includes predetermined management information, and
does not generate the management information if the moving image file obtained by the obtaining unit includes no predetermined management information.

6. The information processing apparatus according to claim 5, wherein the controller replaces the predetermined management information by the generated management information.

7. The information processing apparatus according to claim 1, wherein the controller determines the data length of the moving image data without using the decoder.

8. The information processing apparatus according to claim 1, wherein the controller determines the data length of the moving image data on the basis of information included in a predetermined area of the moving image data.

9. An information processing method comprising:
obtaining a moving image file, wherein the moving image file contains moving image data, which is encoded by variable-length coding, and audio data, which is encoded by variable-length coding;
determining data length of the moving image data;
determining data length of the audio data by not completely decoding the audio data and processing the audio data until a step in which the data length of the audio data can be determined; and
generating management information of the moving image data based on the data length of the moving image data and the data length of the audio data.

10. The information processing method according to claim 9, further comprising:
storing the generated management information and the moving image file in a storage medium in association with each other.

11. The information processing method according to claim 9, wherein inverse quantization is not executed when the audio data is processed until the step in which the data length of the audio data can be determined.

12. The information processing method according to claim 9, wherein inverse discrete cosine transform is not executed when the audio data is processed until the step in which the data length of the audio data can be determined.

13. The information processing method according to claim 9, wherein the management information is generated if the obtained moving image file includes predetermined management information, and
the management information is not generated if the obtained moving image file includes no predetermined management information.

14. The information processing method according to claim 13, wherein the “predetermined management information” is replaced by the generated management information.

15. The information processing method according to claim 9, wherein the data length of the moving image data is determined on the basis of information included in a predetermined area of the moving image data.

16. A non-transitory storage medium readable by a computer and storing a program executed by the computer to execute the method of claim 9.
